(19) United States
(12) Patent Application Publication
(10) Pub. No.: US 2018/0260620 A1
(43) Pub. Date: Sep. 13, 2018

(54) SCOUTING IMAGE MANAGEMENT SYSTEM

(71) Applicants: Patrick Brent, Kalamazoo, MI (US); Donovan Roseboom, Richland, MI (US)

(72) Inventors: Patrick Brent, Kalamazoo, MI (US); Donovan Roseboom, Richland, MI (US)

(21) Appl. No.: 15/896,216

(22) Filed: Feb. 14, 2018

Related U.S. Application Data
(60) Provisional application No. 62/470,590, filed on Mar. 13, 2017.

(51) Int. Cl. G06K 9/00; G06K 9/62; G06F 17/30

(52) U.S. Cl. CPC G06K 9/00362; G06K 9/628; G06F 17/3028; G06F 17/30256; G06F 17/30274

(57) ABSTRACT

A system for managing and sorting images taken by an image capture device utilized by hunters or others wishing to capture images of specific species, or sub-sets of a specific species, wherein the image capture device may be a trail/scouting camera configured to record and store images of subjects at a particular location. The system includes an image management device which has a processor that uses object/facial recognition algorithms or similar processes to analyze biometric image content of the images stored on the trail/scouting camera or copies thereof on a related system or application, and sorts such images into specific file categories based on user selected or pre-determined criteria of the image analysis results. Criteria for sorting images may include, but is not limited to, animal sex (as determined by animal features including but not limited to antlers, horns, etc.), animal size, animal species, and sorting categories include, but are not limited to, “Buck”, “Doe”, “Other”, thereby presenting the user with an organized display of categorized photos based on desired user-determined results.

### CROSS REFERENCE TO RELATED APPLICATIONS

This application claims priority of U.S. provisional patent application Ser. No. 62/470,590, filed Mar. 13, 2017, the disclosure of which is incorporated herein by reference in its entirety.

### FIELD OF THE INVENTION

The invention relates to game animal trail/scouting cameras and, more particularly, to ways, methods or processes of analyzing and manipulating images or data utilizing object/facial recognition algorithms or similar technology to identify desirable animal characteristics for the purpose of sorting images from trail/scouting cameras or similar image capture devices into specific categories based on image content.

### BACKGROUND OF THE INVENTION

The use of trail/scouting cameras or similar image capture devices for the purpose of observing animal activities as they relate to recreational hunting, wildlife photography, animal conservation efforts, or other pursuits is growing increasingly popular. The use and implementation of trail/scouting cameras or similar image capture devices can include the taking or capturing photographs, video footage, thermal images, or other image capture formats for the purpose of observing or scouting game animals at specific locations. These images are generally captured in a digital format, enabling the transfer of said images, by a variety of means, to a personal computer, internet-based application, mobile application platform, or similar system for viewing.

Game animal observation for recreation and/or for scouting in association with hunting and related activities is growing increasingly popular. Game animal observation or scouting activities can include implementation of trail/scouting cameras or similar image capture devices for taking photographs, video footage, or other video recordings. It is known and becoming increasingly popular to use digital scouting cameras for game animal observation, allowing users to, for example, save scouting images onto personal computers (PC) for later viewing.

The use of Trail/Scouting cameras for observing and determining patterns of animal activity in certain areas is generally well known in the art. The apparatus generally includes a digital or video image capture device and a passive sensor (e.g., infrared, motion sensor, etc.) that senses movement or other triggers to activate the image or video capture device focused on the area in which movement is detected. These image capture devices and apparatus often include a delay timer with multiple settings to match specific conditions or locations, thus eliminating unwanted multiple exposures or other non-desired events. Moreover, such apparatus preferably includes high/low sensitivity settings to allow adjustment of the image capture device's effective range in order to record animals and animal activity at a desired distance.

Typical digital trail/scouting cameras and similar image capture devices save or transmit resulting images using known and standard image file types, which allows users to view the images on a PC, mobile device, or similar device using the installed image-viewing software. The data storage media of typical digital scouting/trail cameras and image capture devices is recognized by such devices as being a computer drive or other ancillary computer device, or in some instances images are transmitted by a variety of means (wirelessly or similar) from the image capture device to an ancillary device or online application. Accordingly, to retrieve and view the images, which are generally arranged sequentially, users navigate through the computer device, online application, or file mapping to select the images they want to view, save, log, or transfer to their PCs or may use one of a variety of image-viewing software packages or applications that may be installed on their PCs or similar device to store the images in a database, software application, or the like. Further, images may be transferred to an online photo management application or the like, and may never be actually downloaded directly to a PC or similar device.

The current process requires multiple steps to locate and view images of desired animals. Once the file of images is located, individuals are required to review each image individually and sort them by desired criteria. As trail/scouting cameras are triggered by motion or infrared activity, the images they capture will include every animal or event that has triggered the device and a trail/scouting camera can take thousands of images over only a few days. Many individuals utilizing trail/scouting cameras employ multiple devices to cover different areas, which increases the amount of images requiring review exponentially. Out of the potentially multiple-thousands of images, there may be only a few animals fitting the desired user-defined category, i.e. “Buck”, and the time required to review many thousands of individual images in order to find desired animals is extremely time consuming, tedious, and often confusing for the user.

### OBJECTS OF THE INVENTION

It is an object of the present invention to provide a system for managing and sorting game animal scouting images that improves the state-of-the-art by overcoming the aforesaid problems of the prior art. More specifically, it is an object of the present invention to provide an image management system which reduces the complexity and time required of the user interface compared to the complexity of known image managing systems, or can serve as a component of existing image management systems to reduce the complexity and time required to review images. The object of the present invention is to provide a system which allows scouting images to be filtered and pre-sorted using image analysis via object or facial recognition algorithms/systems to recognize visual biometric characteristics or other visual and physical characteristics (e.g. “antlers/no antlers”) into pre-determined categories based on image content (e.g. “Buck”, “Doe”, or “Other”). This will allow users to immediately access desired images of animals based on their biometric characteristics, thereby eliminating the substantial time and effort previously required in the individual review large numbers of images. In essence, the invention will allow hunters or others who use trail/scouting cameras to access only the images of the specific, desirable animals they are looking for, based on selected criteria which may include, but is not limited to: male/female, antlers/no antlers, animal size, etc. Other sub-categories may include, but are not limited to: location, date/time, etc.

### SUMMARY OF THE INVENTION

The present invention is a system for managing scouting images which includes a trail/scouting camera or similar image capture device configured to record and store (or transmit) images of subjects at a particular location and an image management device or system, which itself includes a processor, or a similar device such as a tablet or mobile phone, or server and a system or software application that sorts said images based on predetermined identifying biometric information gained via image analysis utilizing object or facial recognition systems/algorithms, into pre-determined categories or file folders to facilitate the viewing of the images captured on the trail/scouting camera (or similar image capture device) on a display integrated into or provided separate from the image capture device for conveying the results of said image sorting to a user. In such inventive system, the user is able to readily access only images of desired animals, e.g. “Buck”, versus having to locate desirable animal images via manually sorting through thousands of those images considered undesirable.

In preferred embodiments of the inventive system, (a) the subjects are animals within particular location, (b) the images are sorted by the inventive system via image analysis of predetermined visual biometric criteria or other visual and physical characteristics into pre-determined categories, (c) the sorted images are then made available for viewing to the user via PC, mobile device, online software application, graphic user interface (GUI), or the like.

In some preferred embodiments of the inventive system, the biometric object/facial recognition criteria of desired images can be altered to coincide with different species, e.g. deer, bear, coyote/wolf.

In some preferred embodiments of the inventive system, the sorting process will be incorporated into the operating system of the trail/scouting camera itself, or an attached component to said camera, eliminating the need to transfer images to another device for analysis and subsequent viewing.

In some preferred embodiments of the inventive system, the trail/scouting camera will automatically transfer images wirelessly or by other means to an online or server-based application for analysis by inventive system, and allow users to view sorted desirable images via mobile device or similar applications.

In some preferred embodiments of the inventive system, the filtered results of trail/scouting images will convey other information such as date/time, camera location via global positioning information or similar, etc.

Preferred embodiments of the inventive system for managing game animal scouting images have a game animal trail/scouting camera configured to record and store images of game animals and an image management device or system which include (a) a memory device that stores (or transfers) sorted images retrieved from the game animal trail/scouting camera (b) a display device for displaying the sorted images thereon, (c) multiple classification inputs corresponding to respective ones of multiple game animal characteristics, the multiple classification inputs allowing a user to further classify the image as showing a game animal having one or more of desirable characteristics, or suspected desirable characteristics, and (d) a sorted database organizing the images according to the sorted game animal characteristics of the respective images.

In preferred embodiments of the inventive system, the multiple classification inputs are provided in a graphical user interface that is displayed on the display device. In some of these preferred embodiments, the image management device automatically retrieves the images from the game animal trail/scouting camera.

The game animal trail/scouting camera assigns time and date information to each image in other preferred embodiments of the inventive system. Other preferred embodiments include image-enhancing inputs allowing a user to modify characteristics of the images, and some such embodiments, modifying characteristics of an image does not alter such characteristics of a stored copy of the image.

In many preferred embodiments of the inventive system, the images include still-images and video clips.

In yet additional embodiments of the inventive system, the game animal characteristics determined by image analysis of visual biometric data include gender or age. In some of these embodiments, the image management device determines and displays a herd statement on the display device based at least in part on the user-classified game animal characteristics of the respective images. In some embodiments, the herd statement conveys a ratio of male game animals to female game animals. In some embodiments, the herd statement conveys a ratio of mature game animals to immature game animals. In some embodiments, the herd statement conveys a ratio of large-antlered/horned game animals to small-antlered/horned or non-antlered/horned game animals.

In many preferred embodiments of the inventive system, the image management device is a personal computer, mobile device, or similar personal computing device. Further, in many preferred embodiments, the game animal trail/scouting camera and the image management device are integrated into a single apparatus. Also, in many embodiments, the image management device is based online or as a stand-alone application.

The present invention is also a method of managing game animal scouting images which includes the steps of: (a) recording and storing images of game animals with a game animal scouting camera (b) transferring the images from the game animal scouting camera to an image management device; (c) automatic sorting and classification of the images based on analysis of biometric characteristics of game animals visible in the images; and (d) displaying the images on a display device cooperating with the image management device.

Other objects and purposes of the invention, and variations thereof, will be apparent upon reading the following specification and inspecting the accompanying drawings.

### BRIEF DESCRIPTION OF THE DRAWINGS

FIG. 1 diagrammatically illustrates an inventive system for managing and sorting images taken by an image capture device.

FIG. 2 diagrammatically illustrates the system of the present invention and the categorization of an image collection.

Certain terminology will be used in the following description for convenience and reference only, and will not be limiting. For example, the words “upwardly”, “downwardly”, “rightwardly” and “leftwardly” will refer to directions in the drawings to which reference is made. The words “inwardly” and “outwardly” will refer to directions toward and away from, respectively, the geometric center of the arrangement and designated parts thereof. Said terminology will include the words specifically mentioned, derivatives thereof, and words of similar import.

### DETAILED DESCRIPTION

The invention relates to a system 9 for managing and sorting images taken by an image capture device 10 utilized by hunters or others wishing to capture images of specific species, or sub-sets of a specific species, such as a trail/scouting camera, configured to record and store images of subjects at a particular location 11, such as a trail or other natural area, wherein the images may be first stored on storage media 12 provided in the image capture device 10. The system further includes an image management device 13 which preferably has storage media 14A for storing images received from the image capture device 10 and has a processor and/or a software application 14B that uses object/facial recognition algorithms or similar processes to analyze biometric image content or other visual and physical content of the images received from the image capture device 10, such as the trail/scouting camera, or copies thereof on a related system or application. While storage media 12 and 14B are provided, only one or the other might be provided depending, for example, on whether the image capture device 10 and image management device 13 are formed separate from each other or integrally together as a single unit. The images may form an image collection 15, wherein the image management device 13 and the processor 14B thereof sorts said images into specific file categories 16 based on user selected or pre-determined criteria of the image analysis results. Criteria for sorting images may include, but is not limited to, animal sex (as determined by animal features including but not limited to antlers, horns, etc.), animal size, animal species, and sorting categories 16 include, but are not limited to, “Buck”, “Doe”, “Other”, thereby presenting the user with an organized display of categorized photos based on desired user-determined results. Therefore, the invention relates to image capture devices 10 such as game animal trail/scouting cameras and, more particularly, to a system 9 which implements various ways of analyzing and manipulating images or data utilizing object/facial recognition algorithms or similar technology to identify desirable animal characteristics for the purpose of sorting images from trail/scouting cameras or similar image capture devices 10 into specific categories 16 based on image content.

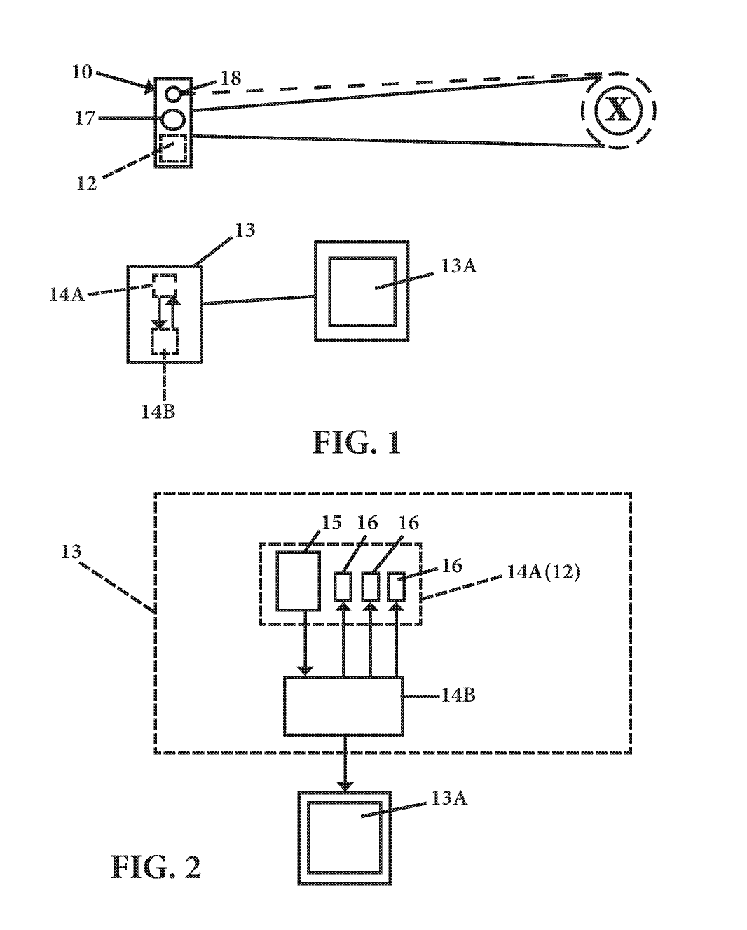

In more detail, the trail/scouting cameras or similar image capture devices 10 of the present invention are used for the purpose of observing animal activities as they relate to recreational hunting, wildlife photography, animal conservation efforts, or other pursuits. The trail/scouting cameras or similar image capture devices 10 of the present invention can operate in various modes to take photographs, video footage, thermal images, or other image capture formats for the purpose of observing or scouting game animals at specific locations diagrammatically indicated in FIG. 1 by reference arrow 11. These images may be captured by the image capture device 10 in a digital format, enabling the transfer of said images, by a variety of means, to the image management device 13, which may comprise a software application hosted by/on a personal computer, an internet-based application, a server-based application, a mobile application platform, or a similar system using software and/or hardware for sorting and categorizing images for eventual presentation on a display 13A which may be a monitor, viewer, mobile device, or similar device. The image management device 13 and the software application thereof may even be built into or provided in combination with the image capture device 10 which could have the display 13A integrated therein.

The image capture device 10 of the present invention is designed for observing and determining patterns of animal activity in certain areas, wherein the image capture device 10 includes a digital or video image capture device or unit 17 that is directed to the location 11 being monitored, and a passive sensor 18 (e.g., infrared, motion sensor, etc.) that senses movement or other triggers in the monitoring location 11 to activate the image or video capture device 17 focused on or aimed at the area or location 11 in which movement is detected. The image capture devices 10 may include a delay timer with multiple settings to match specific conditions or locations, thus eliminating unwanted multiple exposures or other non-desired events. Moreover, the image capture device 10 preferably includes high/low sensitivity settings to allow adjustment of the image capture device's effective range in order to record animals and animal activity at a desired distance.

The image capture device 10 may save resulting images locally or remotely using known and standard image file types, which allows users to view the images on the image management device 13, which may be a PC, mobile device, or similar device using an installed image-viewing software operated by the processor 14B. The data storage media 12 of typical digital scouting/trail cameras and other image capture devices 10 is recognized by the image management device 13 as being a computer drive or other ancillary computer device or storage media. Accordingly, to retrieve and view the images stored on the storage media 12, which are generally arranged sequentially, users navigate through the image management device or computer device 13 or the file mapping accessed thereby to select the images they want to view or transfer to the image management device 13. Where the image management device is a PC, the user may use one of a variety of image-viewing software packages or applications that may be installed on their PCs or other similar device such as a laptop or mobile device.

In a known process using a known trail camera, it requires multiple steps to locate and view images of desired animals. Once a file of images is located, individuals are required to review each image individually and sort them manually by desired criteria. As trail/scouting cameras are triggered by motion or infrared activity, the images they capture will include every animal or event that has triggered the device and a trail/scouting camera can take thousands of images over only a few days. Many individuals utilizing trail/scouting cameras employ multiple devices to cover different areas, which exponentially increases the amount of images requiring review. Out of the potentially multiple-thousands of images, there may be only a few animals fitting the desired user-defined category, i.e. “Buck”, and the time required to review many thousands of individual images in order to find desired animals is extremely time consuming, tedious, and often confusing for the user.

The present invention provides an image management system 9, which reduces the complexity and time required of the user interface compared to the complexity of known image managing systems, or can serve as a component of existing image management systems to reduce the complexity and time required to review images. The present invention provides a system 9 which allows scouting images to be filtered and pre-sorted using image analysis performed by the image management device 13, which filters and pre-sorts via object or facial recognition algorithms/systems to recognize visual biometric characteristics (e.g. “antlers/no antlers”) into pre-determined categories based on image content (e.g. “Buck”, “Doe”, or “Other”). This allows users to immediately access desired images of animals based on their biometric characteristics, thereby eliminating the substantial time and effort previously required in the individual review large numbers of images. In essence, the combination of the image management device 13 with the image capture device 10 allows hunters or others who use the image capture device 10 to access only those images in the image collection 15 showing the specific, desirable animals they are looking for, based on selected criteria which may include, but is not limited to: male/female, antlers/no antlers, animal size, etc. Other sub-categories may include, but are not limited to: location, date/time, etc.

The system 9 is provided for managing scouting images and includes a trail/scouting camera or similar image capture device 10 configured to record and store on the storage media 12 images of subjects at the monitored location 11. The system 9 further includes the image management device 13, which itself includes the processor 14B, wherein the image management device 13 may be a PC or a similar device such as a tablet or mobile phone that connects to the image capture device 10. The image management device 13 may be integrated together with the image capture device 10 as a single unit. The image management device 13 operates a system or software application that sorts said images collected by the image capture device 10 based on predetermined identifying biometric information gained via image analysis utilizing object or facial recognition systems/algorithms, and after image analysis, the image management device 13 sorts the image collection 15 into one or more pre-determined categories or file folders 16 to facilitate the viewing of the categorized images on the display 13A associated with the image management device 13 that may be provided separate from or integrated into the trail/scouting camera or similar image capture device 10, wherein the display 13A conveys the results of said image sorting to a user. As a result, the user is able to readily access only the categorized subset of images showing desired animals, e.g. “Buck”, versus having to locate desirable animal images via sorting through thousands of the unsorted images originally collected, wherein many of the original collection of images may be considered undesirable.

In preferred embodiments of the inventive system 9, (a) the subjects are animals within particular location 11 being monitored by the image capture device 10, (b) the collection 16 of images are sorted by the inventive system via image analysis of predetermined visual biometric criteria into pre-determined categories 15, and (c) the sorted images are then made available for viewing to the user via PC, mobile device, online software application or interface, or similar means for transmitting the images to one or more suitable displays 13A. In some preferred embodiments of the inventive system, the biometric object/facial recognition criteria of desired images can be altered in the image management device 13 to identify, sort and categorize different species, e.g. deer, bear, coyote/wolf. In some preferred embodiments of the inventive system, the sorting process will be incorporated into the operating system of the trail/scouting camera itself, eliminating the need to transfer images to another device for analysis and subsequent viewing.

In some preferred embodiments of the inventive system, the image capture device 10 such as the trail/scouting camera will include a transmitter to automatically transfer images wirelessly or by other means to an online based application for analysis by the image management device 13 of the present system 9, and allow users to view sorted desirable images remotely from the image capture device 10 via mobile device or similar applications having the display 13A thereon. These viewing devices may be provided separate from the image management device 13 containing the processor 14B with which the sorting and categorizing step is performed. In some preferred embodiments of the inventive system, the filtered or categorized results of trail/scouting images present in the image collection 15 will convey other information such as date/time, camera location via global positioning information or similar, etc.

Preferred embodiments of the inventive system for managing game animal scouting images have the image capture device 10 configured as a game animal trail/scouting camera that is configured to record and store images of game animals and an image management device 13 which includes (a) a memory device or storage media 14A that stores sorted or categorized images retrieved from the game animal trail/scouting camera (b) a display device 13A for displaying the sorted images thereon, (c) multiple classification inputs for the processor 13 corresponding to respective ones of multiple game animal characteristics, wherein the multiple classification inputs allow a user to further classify the image as showing a game animal having one or more of desirable characteristics, or suspected desirable characteristics, and (d) a sorted database organizing the images according to the sorted game animal characteristics of the respective images which may be sorted into multiple categories.

In preferred embodiments of the inventive system, the multiple classification inputs are provided in a graphical user interface that is displayed on the display device 13A. In some of these preferred embodiments, the image management device 13 automatically retrieves the images from the game animal trail/scouting camera 10.

The game animal trail/scouting camera assigns time and date information to each image in other preferred embodiments of the inventive system. Other preferred embodiments include image-enhancing inputs allowing a user to modify characteristics of the images, and some such embodiments, modifying characteristics of an image does not alter such characteristics of a stored copy of the image.

In the preferred embodiments of the inventive system, the images may include still-images and video clips.

In yet additional embodiments of the inventive system, the game animal characteristics determined by image analysis of visual biometric data include gender or age. In some of these embodiments, the image management device determines and displays a herd statement on the display device based at least in part on the user-classified game animal characteristics of the respective images. In some embodiments, the herd statement conveys a ratio of male game animals to female game animals. In some embodiments, the herd statement conveys a ratio of mature game animals to immature game animals. In some embodiments, the herd statement conveys a ratio of large-antlered/horned game animals to small-antlered/horned or non-antlered/horned game animals.

In some preferred embodiments of the inventive system, the image management device 13 is a personal computer, or similar personal computing device. Further, in one preferred embodiment, the game animal trail/scouting camera 10 and the image management device 13 may be integrated into a single apparatus. Also, in many embodiments, the image management device 13 may be based online or may be provided as a standalone application.

The present invention is also a method of managing game animal scouting images which includes the steps of: (a) recording and storing images of game animals with a game animal scouting camera or other image capture device 10; (b) transferring the images from the game animal scouting camera 10 to an image management device 13; (c) automatically sorting and categorizing the images based on biometric characteristics of game animals visible in the images; and (d) displaying the images on a display device 13A cooperating with the image management device 13.

Although particular preferred embodiments of the invention have been disclosed in detail for illustrative purposes, it will be recognized that variations or modifications of the disclosed apparatus, including the rearrangement of parts, lie within the scope of the present invention.

What is claimed:

1. A system for managing scouting images comprising:
an image capture device configured to capture images of physical subjects at a particular location, said physical subjects being of different physical types exhibiting different biometric characteristics, which allow identification of said physical types of said subjects present in said capture images; and
an image management system in communication with said image capture device for receiving said images therefrom, said image management system including at least one of a processor and a software application configured to perform image analysis utilizing an object or facial recognition system or algorithm to identify said biometric information of any said subject present in said images, and also configured to perform image sorting that sorts said captured images based on predetermined identifying biometric information into pre-determined categories to facilitate subsequent viewing of said images captured on said image capture device, said one of said processor and said software application communicating with a display integrated into or provided separate from said image capture device for conveying results from said image sorting to a user viewing said display.

2. The system according to claim 1, wherein said image sorting identifies specific physical types of said subjects wherein said specific physical type is a targeted animal.

3. The system according to claim 1, wherein said captured images are sorted via said image analysis based upon predetermined visual biometric criteria or other visual and physical characteristics into said pre-determined categories and stored as sorted images by said processor based upon said pre-determined categories.

4. The system according to claim 3, wherein after storage of said sorted images based upon said pre-determined categories, said sorted images are available for viewing to the user via said display which is associated with one of a PC, mobile device, online software application, or a graphical user interface (GUI).

5. The system according to claim 1, wherein said identifying biometric information includes biometric object or facial recognition criteria of desired images which allows identification of said physical types corresponding to different species of animals.

6. The system according to claim 5, wherein said system permits alteration of said biometric object or facial recognition criteria to be sorted so that a targeted animal can be selected by a user from one of a plurality of different species.

7. A system of managing scouting images for users wishing to capture and review images of specific species, or sub-sets of a specific species, said system comprising:
an image capture device configured as a scouting camera to record images of physical subjects at a montiored location in an environment, said physical subjects being of different physical types differentiated by specific species or sub-sets of a specific species exhibiting different biometric characteristics, said biometric characteristics allowing identification of said physical types;
an image management system which is in digital communication with said image capture device to receive at least a portion of said captured images from said image capture device;
storage media in digital communication with at least one of said image capture device and said image management system for storing at least a portion of said captured images;
said image management system including an image management device comprising at least one of a processor and a software application that is in digital communication with said storage media for receiving at least a portion of said captured images therefrom, and is configured to perform object/facial recognition algorithms or processes to analyze visual and physical content of said captured images including biometric image content;
at least one of said processor and said software application configured to perform image analysis of said captured images with said image analysis utilizing object or facial recognition systems/algorithms to identify said visual and physical content including said biometric information of any said subject present in said captured images, and also configured to perform image sorting that sorts said analyzed images based on predetermined identifying biometric information into pre-determined categories to facilitate subsequent viewing of said analyzed images captured on said image capture device, said image management device communicating with a display integrated into or provided separate from said image capture device for conveying results from said image sorting to a user viewing said display.

8. The system according to claim 7, wherein said captured images form an image collection, wherein said image management device sorts said images into said predetermined categories based on user-selected or pre-determined criteria for sorting said captured images.

9. The system according to claim 8, wherein said criteria for sorting said captured images comprise physical features including gender of an animal as determined by visible animal features comprising the presence or absence of antlers, animal size and animal species.

10. The system according to claim 8, wherein said image management device and said image capture device permit users to access only said captured images in said image collection showing specific, desirable animals being searched for by said user based on selected criteria which comprise at least one of male/female, antlers/no antlers, animal size.

11. The system according to claim 7, wherein said software application of said image management device comprises at least one of a software application hosted on a personal computer, an internet-based software application, a server-based software application, and a mobile application platform configured for sorting and categorizing said captured images.

12. The system according to claim 7, wherein said image capture device is operable in at least one of a plurality of modes to capture images as photographs, video footage, thermal images, or other image capture formats for the purpose of observing or capturing images of game animals at particular exterior locations.

13. The system according to claim 7, wherein said image capture device comprises a digital or video image capture unit that is directed to said monitored location, and a passive sensor that senses triggers including movement in the monitored location to activate the image capture unit directed towards the monitored location in which said trigger is detected.

14. The system according to claim 7, wherein said storage media comprises first storage media on said image capture device which initially stores said captured images and said display is configured to permit said user to retrieve and view said captured images stored on said image capture device, and select selected images for viewing or transfer to said image management device.

15. The system according to claim 14, wherein said image management device is integrated together with said image capture device as a single unit or configured separately from said image capture device.

16. The system according to claim 15, wherein said storage media comprises second storage media on said image management device which receives said captured images from said first storage media.

17. A method of managing game animal scouting images which includes the steps of:
(a) generating images of detected animals with an image capture device monitoring a monitoring area upon detection of said detected animals disposed in said monitoring area and storing captured images of said detected animals;
(b) transferring said captured images from said image capture device to an image management device;
(c) automatically sorting and classifying said captured images including the step of analyzing biometric characteristics of said detected animals visible in said captured images with at least one of a processor and a software application;
(d) storing a portion of said captured images as sorted images which exhibit desirable biometric characteristics; and
(d) displaying said sorted images which exhibit said desirable biometric characteristics on a display device cooperating with said image management device.

18. The method according to claim 17, wherein said sorting and classifying step includes the step of sorting said captured images into one or more pre-determined categories to facilitate the viewing of said sorted images on said display.

19. The method according to claim 18, wherein said sorted images only include those captured images which exhibit a desirable species of a game animal and exhibit desirable physical characteristics possessed by only a portion of said game animals within said desirable species.

20. The method according to claim 19, wherein said desirable physical characteristics include gender and size.
